(19) United States
(12) Patent Application Publication
(10) Pub. No.: US 2011/0291777 A1
(43) Pub. Date: Dec. 1, 2011

(54) MAGNETICALLY OPERATED SWITCH

(76) Inventors: Winfried Stiltz, Rainau (DE); Christian Uhlig, Aichtal (DE); Achim Weirowski-Herz, Nagold (DE); Roland Hengstler, Rottenburg (DE)

(21) Appl. No.: 13/115,448

(22) Filed: May 25, 2011

(30) Foreign Application Priority Data
May 29, 2010 (DE) 10 2010 022 008.6

(51) Int. Cl. H01H 9/00

(52) U.S. Cl. 335/205

(57) ABSTRACT

A magnetically operated switch has a receiver which is mounted such that it is moveable between two switch positions, and which is used to actuate the magnetically operated switch, a housing relative to which the receiver is movably supported, a magnet, a magnetic sensor which interacts with the magnet, and evaluation electronics which are assigned to the magnetic sensor and can be used to generate a switch signal that is dependent on the switch positions of the receiver. To provide an improved magnetically operated switch, it has a magnetic shield which interacts with the magnet, the shield and the magnet are in different positions relative to one another depending on the switch positions of the receiver, and the evaluation electronics generate the switch signal depending on the relative positions.

### CROSS-REFERENCE TO RELATED APPLICATION

The invention described and claimed hereinbelow is also described in German Patent Application DE 10 2010 022 008,6 filed on May 29, 2010. This German Patent Application, whose subject matter is incorporated here by reference, provides the basis for a claim of priority of invention under 35 U.S.C. 119(a)-(d).

### BACKGROUND OF THE INVENTION

The invention relates to a magnetically operated switch comprising a receiver which is mounted such that it can move between two switch positions, and which is used to actuate the magnetically operated switch, a housing relative to which the receiver is movably mounted, a magnet, a magnetic sensor which interacts with the magnet, and evaluation electronics which are assigned to the magnetic sensor and can be used to generate a switch signal that is dependent on the switch positions of the receiver.

Magnetically operated switches are known; they typically comprise a magnet and evaluation electronics that interact with the magnet, wherein the magnet is mounted such that it is movable depending on actuation, for instance, and the movements of which can be detected using assigned evaluation electronics to generate a switch signal. Document DE 10 2007 031 886 A1 relates to a household appliance comprising a door which can be secured using a closing device, and a door position detection device comprising at least one permanent magnet and one magnetically operated switch which can be brought into the range of action of the permanent magnet by moving the door. It is provided that the magnetically operated switch is a Hall sensor.

### SUMMARY OF THE INVENTION

The problem addressed by the invention is that of providing an improved magnetically operated switch, in particular to permit a more compact design and/or greater operational reliability

The problem is solved, in the case of a magnetically operated switch comprising a receiver which is mounted such that it can move between two switch positions, and which is used to actuate the magnetically operated switch, a housing relative to which the receiver is movably mounted, a magnet, a magnetic sensor which interacts with the magnet, and evaluation electronics which are assigned to the magnetic sensor and can be used to generate a switch signal that is dependent on the switch positions of the receiver, in that the magnetically operated switch has a magnetic shield which interacts with the magnet, wherein the shield and the magnet are in different positions relative to one another depending on the switch positions of the receiver, and the evaluation electronics generate the switch signal depending on the relative position.

A relatively compact design of the magnetically operated switch can be ensured, since even relatively small displacements of the magnet relative to the shield induce a relatively great change to a magnetic field that surrounds the magnet; advantageously the change in the magnetic field can be detected by the magnetic sensor.

In one embodiment of the magnetically operated switch, the housing comprises the magnetic shield; advantageously, the housing comprises the magnetic shield, and therefore the housing can fulfill two functions simultaneously. In addition to the function of housing the components of the magnetically operated switch, the additional function of local shielding—which is used for the switch function—can be performed directly by the housing, thereby resulting in a particularly compact design of the magnetically operated switch.

In another embodiment of the magnetically operated switch, the magnetically operated switch is designed as a plunger-operated switch, wherein the receiver is an actuatable plunger of the plunger-operated switch. Advantageously, the magnetically operated switch can be actuated via the plunger.

In another embodiment of the magnetically operated switch, the magnet is an annular magnet which is installed in a stepped bore—which forms the shield—together with the plunger in a longitudinally displaceable mariner. Advantageously, the stepped bore can form a sliding support for the plunger and the magnet shield. For this purpose, the housing can advantageously comprise a material that shields magnetic field lines.

In one embodiment of the magnetically operated switch, the stepped bore has a first diameter in which the plunger is supported in a longitudinally displaceable manner, a second, larger diameter which abuts the first diameter and in which the magnet is installed in a longitudinally displaceable manner, and a third diameter which is greater than the second diameter and in which the magnetic sensor is disposed. Advantageously, the stepped bore can be installed easily in the housing of the plunger-operated switch. Advantageously, the second diameter forms the shield, wherein the third diameter can advantageously form an open space through which field lines of the magnet can easily extend. As soon as the magnet is moved away from the shield into the third diameter, field lines extend through the open space, and this can be detected by the magnetic sensor.

In another embodiment of the magnetically operated switch, the evaluation electronics comprise the magnetic sensor and are installed in the third diameter of the stepped bore. Advantageously, the evaluation electronics are also accommodated in the third diameter and are designed as an integrated component together with the magnetic sensor.

In another embodiment of the magnetically operated switch, the evaluation electronics perform self-diagnosis after the power supply has been interrupted. Advantageously, a signal is made available that characterizes a function of the magnetically operated switch.

The problem is furthermore solved by a motor vehicle comprising a magnetically operated switch described above. The advantages described above are attained.

Further advantages, features, and details will become apparent from the description that follows, in which at least one embodiment is described in detail, with reference to the drawing as necessary. Features that are described and/or depicted graphically form the subject matter of the invention individually or in any reasonable combination thereof, possibly also independently of the claims, and, in particular, can also be the subject matter of one or more separate applications. Identical, similar, and/or identically-acting parts are labeled using the same reference characters.

### BRIEF DESCRIPTION OF THE DRAWNS

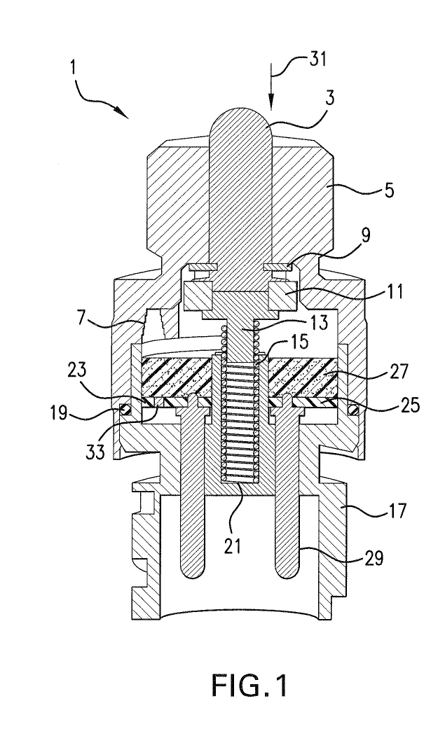

FIG. 1 shows a longitudinal sectional view of a plunger-operated switch designed as a magnetically operated switch;

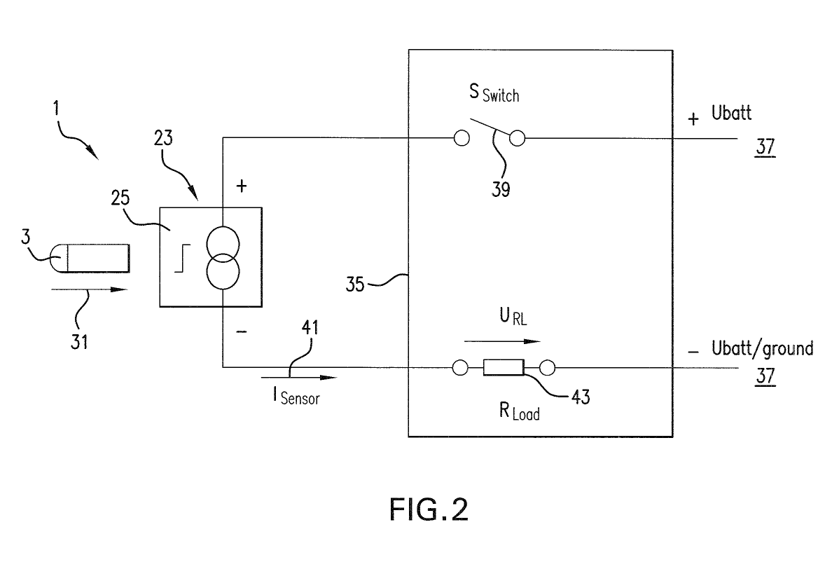

FIG. 2 shows a schematic view of a switch arrangement of the plunger-operated switch depicted in FIG. 1;

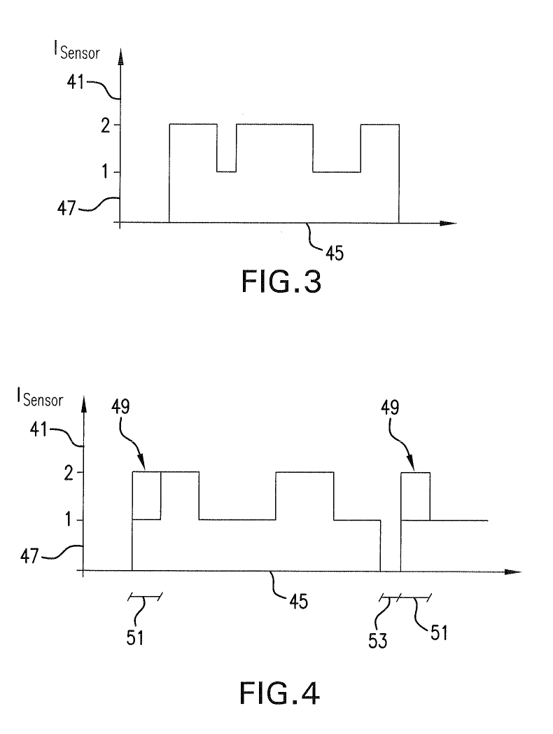

FIG. 3 shows a diagram of a sensor signal of the magnetically operated switch depicted in FIG. 1 as a function of time; and

FIG. 4 shows the diagram depicted in FIG. 4, although with the sensor signal plotted as a function of time during and after two self-diagnoses,

### DESCRIPTION OF THE PREFERRED EMBODIMENTS

FIG. 1 shows a longitudinal sectional view of a magnetically operated switch 1 designed as a plunger-operated switch. Magnetically operated switch 1 comprises a receiver which can be displaced between two switch positions, is designed as a plunger 3, and is supported in housing 5 in a longitudinally displaceable manner for this purpose.

Plunger 3 is accommodated in a stepped bore 7 of housing 5. In the region of plunger 3, stepped bore 7 has a first, smallest diameter which transitions into a second, larger diameter, The second, larger diameter transitions into a third diameter which is even larger. Finally, the third diameter transitions into a fourth, larger diameter, and into a fifth, larger diameter. In all, stepped bore 7 of housing 5 has four steps and five diameters. Alternatively and/or in addition thereto, it is possible to replace cylindrical stepped bore 7 with any cross section, such as a rectangularly stepped cross section.

A captive-lock washer 9, which is fixedly assigned to plunger 3 in a form-fit manner, impacts one step of stepped bore 7 between the first diameter and the second diameter. Captive-lock washer 9 can be designed as a snap ring, for instance, which can be clipped in a corresponding circumferential groove in plunger 3.

At one inner end, plunger 3 comprises a step into which a magnet 11 designed as an annular magnet engages. A stepped, plate-shaped magnet holder 13 encloses magnet 11 from one side opposite plunger 3, and therefore magnet 11 is secured in a form-fit manner between the step of plunger 3 and a step of magnet holder 13.

Magnet holder 13 comprises a spindle on the side opposite magnet 11, on which a compression spring 15 is installed. Compression spring 15 presses magnet holder 13 against magnet 11, presses magnet 11 against the step of plunger 3, and, finally, presses captive-lock washer 9 against the step between the first and the second diameter of stepped bore 7 of housing 5. This position, in which magnetically operated switch 1 is not actuated, is shown in FIG. 1.

Housing 5 comprises an upper part into which the stepped bore is installed. Furthermore, housing 5 comprises a lower part which is designed as a bayonet connector 17 which engages in stepped bore 7 in a form-fit, frictional, and/or non-positive manner. Furthermore, a sealing ring 19 is disposed at a fourth step, i.e. between the fourth diameter and the fifth diameter of stepped bore 7, in order to seal the upper part and the lower part.

On an inner side, bayonet connector 17 comprises a blind hole 21 which forms a spring receptacle for compression spring 15 and, on a bore base, forms a counter-bearing or a spring stop for compression spring 15, and therefore compression spring 15 rests against magnet holder 13 and against the bore base of blind hole 21, or applies a spring force to same and thereby presses them apart.

Furthermore, evaluation electronics 23 comprising a printed circuit board 25 are disposed in the interior of bayonet connector 17. Printed circuit board 25 is cast with a casting compound 27 and is secured inside bayonet connector 17 or housing 5 by way of casting compound 27.

An open space remains between casting compound 27 and magnet holder 13 or magnet 11, into which magnet 11 moves when plunger 3 is actuated. The open space is formed by the third diameter of stepped bore 7. The casting compound and printed circuit board 25 are likewise located in the third diameter which extends further through bayonet connector 17. Field lines of magnet 11 can easily extend through the open space and the casting compound.

For contacting printed circuit board 25 of evaluation electronics 23, two plug pins 29 of bayonet connector 17 are assigned thereto. Electronic magnetically operated switch 1 can be contacted via plug pins 29 of bayonet connector 17, Plug pins 29 form a two-wire interface for reading out a switch position of magnetic switch 1.

Magnetically operated switch 1 is shown in a first switch position in FIG. 1. In the first switch position, magnet 11 is located within the second diameter of stepped bore 7 of housing 5. Housing 5 can comprise a material that shields magnetic field lines. Clearly, the first switch position of magnet 11, which is shown in FIG. 1, is shielded to the greatest extent. In a second switch position, which can be attained, by pressing plunger 3 downward in the direction of arrow 31, magnet 11 is located in a second position relative to housing 5, wherein magnet 11 is moved into the open space of the third diameter of stepped bore 7 of housing 5; thereby advantageously releasing magnetic field lines of magnet 11, which can therefore also extend through printed circuit board 25 of evaluation electronics 23. A magnetic sensor 33 is integrated on printed circuit board 25 of evaluation electronics 23 for detecting said change. Advantageously, magnetic sensor 33 can detect the change in the magnetic field within the open space of housing 5, wherein a corresponding switch position or actuation position of plunger 3 can be output via the two-wire interface of the two plug pins 29. Plunger 3 is therefore a receiver for detecting the two switch positions of magnetic switch 1.

FIG. 2 shows a schematic view of a switch arrangement of magnetic switch 1 shown in FIG. 1.

The direction of motion of longitudinally displaceable plunger 3 is indicated schematically using arrow 31. Plunger 3 acts via magnet 11, which is not shown, onto magnetic sensor 33 which is advantageously designed as a Hall sensor. Advantageously, the Hall sensor generates a signal which is independent of a motion of magnet 11 relative to magnet sensor 33, or a voltage which is dependent only on a field strength. Advantageously, magnetic sensor 33, which is located on printed circuit board 25 of evaluation electronics 23 inside housing 5 of magnetically operated switch 1, is supplied with electrical energy via an electronic supply unit and can be read out by same.

To this end, electronic control unit 35 is assigned to an electrical energy source 37 which is indicated only by reference character 37 in FIG. 2. Electrical energy source 37 can be a battery, for instance, in particular a 12-volt or 24-volt battery.

Electronic control unit 35 comprises an electronic switch 39 which impresses a sensor current 41 onto two-wire interface of plug pins 29 depending on the switch position of magnetically operated switch 1 or on the position of magnet 11 relative to stepped bore 7 of housing 5, which is used as a shield. Furthermore, electronic control unit 35 comprises a load resistor 43 through which sensor current 41 flows. Advantageously, a corresponding voltage drops across load resistor 43, which can be read out, advantageously, in order to determine the switch position of magnetically operated switch 1. Sensor current 41 is labeled with reference character I_{Sensor} in FIG. 2. The voltage that drops across load resistor 43 is labeled with reference character U_{RL}. Load resistor 43 is labeled with reference character R_{load} in FIG. 2. An electrical voltage of electrical energy source 37 is labeled in FIG. 2 with the reference character +UBatt or −UBatt/ground.

FIG. 3 shows a diagram of sensor current 41 depicted in FIG. 2 as a function of time. To this end, time is plotted on an x-axis 45, and sensor current 41 is plotted on a y-axis 47. As shown, sensor current 41 initially does not flow through the two-wire interface of plug pins 29. This corresponds to a switched-off state of magnetically operated switch 1, wherein electrical energy source 37 is separated from the electronic control unit and, therefore, evaluation electronics 23, using electronic switch 39, for instance. Sensor current 41 rises to a value which is labeled with numeral 2 in FIG. 3 as an example. As time progresses, sensor current 41 drops, on one flank, to a value which is labeled with numeral 1 in FIG. 3 as an example. This corresponds to magnetically operated switch 1 moving from the switch position shown in FIG. 1 into an actuated switch position. As time progresses further, the switch positions change in the opposite direction, i.e. an increase in sensor current 41 is plotted along x-axis 45. As time progresses further, two additional flanks occur, i.e. a falling flank and a rising flank, each of which indicates a change in switch position, and finally sensor current 41 drops completely to a value 0 which corresponds to magnetically operated switch 1 being turned off, i.e, being separated from electrical energy source 37.

FIG. 4 shows a graph of sensor current 41 over time, which is analogous to the depiction in FIG. 3. In contrast to FIG. 3, evaluation electronics 23 and electrical control unit 35 shown in FIG. 4 are designed such that they perform a self-test 49 after being switched off, i.e. after voltage has been applied or after connection to electrical energy source 37. Self-test 49 covers a fixedly defined time period 51 and outputs a result of self-test 49 via the two-wire interface of plug pins 29 of bayonet connector 17. After the result of self-test 49 is output, a current switch position of magnetically operated switch 1 is output. This is indicated, by a plurality of flanks of sensor current 41, which fall and rise in alternation as time progresses according to FIG. 4. Self-test 49 is performed after magnetically operated switch 1 is turned on for the first time.

As shown in FIG. 4 as time progresses, self-test 49 can also be repeated, advantageously, after the supply voltage to electrical energy source 37 has been interrupted for a further time period 53 which can be shorter than period 51, for instance.

The connection to the energy supply or electrical source 37, and signal transmission, take place via a two-wire line or the two-wire interface of the two plug pins 29. The switching state or the two switch positions of magnetically operated switch 1 are transmitted to an appropriate control unit via a change between two impressed currents of sensor current 41 brought about by electronic switch 49. Faults in supply leads, such as short circuits, such as a ground connection, a UB connection, and/or line interruptions can be advantageously detected by the control unit by monitoring said currents, Due to the elimination of mechanical contacts, magnetically operated switch 1, which is designed as an electronic, plunger-operated switch, is advantageously suitable for performing a very large number of switch changes, since the properties remain constant for the duration of the service life.

The shape of plunger 3 is designed such that inflowing and oufflowing liquid media can flow unobstructed upon actuation. After the supply voltage has been applied to electrical energy source 37, a defined time period or time period 51 is allowed to pass, to enable information transmissions, for self-test 49 in particular, to take place alternatively and/or in addition. During time period 51, the information on self-test 49 and/or a switch type which is designed as a normally-closed or a normally-open contact can be transmitted to the control unit. Once time period 51 expires, the current switching state or the corresponding switch position of plunger 3 can be output.

Advantageously, electronic, magnetically operated switch 1 can be replaced by a mechanical, plunger-operated switch. Advantageously, relatively longer stability and a relatively large number of switch changes are attained. Advantageously, no contact changes are brought about due to wear, penetration by oil and/or foreign substances; in particular, casting compound 27 which protects printed circuit board 25 of evaluation electronics 23 is advantageously provided, Advantageously, magnetically operated switch 1 can be designed to perform a diagnosis, in particular to support a higher-order diagnostic function, e.g. of a motor vehicle in which magnetically operated switch 1 is installed. Advantageously, two lines are used to provide the supply from electrical energy source 37 and to transmit signals, i.e. the two lines of plug pins 29.

Advantageously, a more compact and simple structure is obtained, wherein the design of housing 5 is the same and/or very similar to that of alternative mechanical, plunger-operated switches.

Plunger 3 is held in the resting position by compression spring 15, magnet holder 13, magnet 11, and captive-lock washer 9. In the resting position, magnet 11 is enclosed by magnetizable housing 5 such that a magnetic field of magnet 11 is short-circuited, and field lines extend substantially in magnet 11 itself and in housing 5. By way of plunger 3 pressing inwardly, magnet 11 is moved out of the enclosure through housing 3, thereby eliminating the bundling of the magnetic field lines and allowing them to extend through the air of the open space of the second diameter of stepped bore 7 of housing 5.

The advantageous result is a steep increase of the magnetic field strength in the region of magnetic sensor 33 which is designed as a Hall sensor and is located on printed circuit board 25 of evaluation electronics 23. If a predefined threshold is exceeded, said position of plunger 3 is evaluated as “switch actuated” by appropriate electronics on printed circuit board 25, and the impressed current or sensor current 41 is switched from the unactuated state to the actuated state in the two-wire interface of plug pins 29. Said mechanical arrangement of plunger 3, magnet 11, and housing 5 makes it possible for a switching point to be determined for a change from the unactuated state to the actuated state via the geometric design of housing 5, in particular stepped bore 7 of housing 5, and an individual adjustment of the switching point is not required.

The switching state or the current switch position of plunger 3 is output via the two-wire interface such that, when a voltage is applied in the correct polarity to both connections of plug pins 29 via the switch, a constant load current or control current 41 corresponding to the switching state flows. Preferably, the current of one of the states is twice as great as that of the other state. To enable the connected control unit to evaluate the switching state, it is sufficient to incorporate a suitable testing resistor into the current circuit, such as load resistor 43. A voltage U_{RL} corresponding to the switching state is then present at the load resistor, Since the switching state is assigned to one of two possible currents, it is possible, by reference to the voltage present at the testing resistor, to deduce the function of the electronic switch to detect potential faults in the connecting lines, such as a short circuit, e.g. a UB short, a short circuit to ground, and/or an interruption of the supply voltage in electrical energy source 37.

Alternatively and/or in addition thereto, it is possible to design magnetically operated switch 1 to perform a self-test or a self-diagnosis. By integrating electronic components in the integrated circuit, it is possible to combine a large number of functions in the smallest possible space. It is therefore possible, alternatively and/or in addition thereto, to include an analog/digital converter and/or a microcontroller in the electronics of the electronic, plunger-operated switch or magnetically operated switch 1. They can monitor the function of the electronic, plunger-operated switch or individual important components, such as the Hall sensor of magnetic sensor 33. To forward the result of said monitoring to the connected control unit, the current or sensor current 41 can be assigned to one of the possible current intensities and output by magnetically operated switch 1 for a brief time period, e.g. a defined portion of time period 51 in accordance with the result of the self-test, i.e. okay or not okay. Magnetically operated switch 1 then returns to outputting the current switching state or switch position of plunger 3. Fixed time period 51 after which the supply voltage of electrical energy source 37 was applied is used to output the result of self-test 49. During operation, self-test 49 can be restarted by briefly turning off the supply voltage (FIG. 4).

Alternatively and/or in addition thereto, it is possible for the electronic, plunger-operated switch to operate in a pulsed manner. In general, it is also possible to turn on the electronic, plunger-operated switch or magnetically operated switch 1 for only a brief time period and to request the information via the self-test, to then request the position or switch position of plunger 3, and to then turn off magnetically operated switch 1. Advantageously, said operating mode results in a substantially lower mean energy consumption, thereby advantageously relieving a vehicle electrical system of a not-shown motor vehicle comprising magnetically operated switch 1, e.g. when an internal combustion engine of the motor vehicle idles, In that particular case, the vehicle electrical system can be supplied with electrical energy for a longer period of time by electrical energy source 37. Furthermore, a substantially lower power loss occurs in electrical components of magnetically operated switch 1, thereby reducing a thermal load on components such as printed circuit board 25 and evaluation electronics 23 and extending a service life of the components, in particular when ambient temperatures are relatively high.

Alternatively and/or in addition thereto, it is feasible for magnet 11 to be fixedly assigned to housing, 5, and for a separate shield, which interacts with magnet 11 and is mounted such that it can move with plunger 3, to be assigned to plunger 3.

It will be understood that each of the elements described above, or two or more together, may also find a useful application in other types of constructions differing from the types described above.

While the invention has been illustrated and described as embodied in a magnetically operated switch, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A magnetically operated switch comprising:
a receiver which is mounted moveably between two switch positions, and which actuates the magnetically operated switch,
a housing relative to which the receiver is movably mounted,
a magnet,
a magnetic sensor which interacts with the magnet,
evaluation electronics which are assigned to the magnetic sensor and generates a switch signal that is dependent on the switch positions of the receiver, wherein
the magnetically operated switch has a magnetic shield which interacts with the magnet,
wherein the shield and the magnet are in different positions relative to one another depending on the switch positions of the receiver,
and wherein the evaluation electronics generate the switch signal depending on the relative positions.

2. The magnetically operated switch according to claim 1, wherein the housing has a the magnetic shield.

3. The magnetically operated switch according to claim 2, wherein the magnetically operated switch is a plunger-operated switch, wherein the receiver is an actuatable plunger of the plunger-operated switch.

4. The magnetically operated switch according to claim 3, wherein the magnet is an annular magnet installed in a stepped bore—which forms the shield—together with the plunger in a longitudinally displaceable manner.

5. The magnetically operated switch according to claim 4, wherein the stepped bore has a first diameter in which the plunger is accommodated, a larger, second diameter in which the magnet is accommodated, a larger third diameter in which the magnetic sensor is accommodated.

6. The magnetically operated switch according to claim 5, wherein the evaluation electronics comprise the magnetic sensor and are accommodated in the third diameter of the stepped bore (7).

7. The magnetically operated switch according claim 1, wherein the magnetically operated switch is configured so that a self-test of the magnetically operated switch is performed in a condition selected from the group consisting of after a supply voltage has been applied, after the supply voltage has been interrupted, and both,

8. A motor vehicle comprising a magnetically operated switch according to claim 1.
